(19) United States
(12) Patent Application Publication
(10) Pub. No.: US 2003/0033586 A1
(43) Pub. Date: Feb. 13, 2003

(54) Automated system and method for software application quantification

(76) Inventor: James Lawler, San Diego, CA (US)

Correspondence Address: Karl M. Steins, Steins & Associates, Suite 120, 2333 Camino del Rio South, San Diego, CA, 92108, US

(21) Appl. No.: 09/928,272

(22) Filed: Aug. 9, 2001

(51) Int. Cl. G06F 9/44

(52) U.S. Cl. 717/101; 717/104

(57) ABSTRACT

An Automated System and Method for Software Application Quantification is disclosed. The preferred method and system enables the user to create an object-oriented representation of a prospective or existing software application, and then quantify the object-oriented representation with a function point count automatically created from the object-oriented model.

### BACKGROUND OF THE INVENTION

1. Field of the Invention

This invention relates to project estimating and management systems and, more specifically, to an Automated System and Method for Software Application Quantification.

2. Description of Related Art

Software application sizing and measuring is a fairly complicated process that has become increasingly important to the software development industry. In particular, there are three functions for which software sizing is desired: (1) measuring an existing software application, typically in order to justify certain budget allocations (“budgeting”); (2) estimating the size of a proposed software application, such as for vendor project quotation (“estimating”); and (3) tracking a software development project before, during and after development in order to forecast (on effort, schedule, cost and complexity) other project management functions (“project management”). The goal of software sizing is to relate the size of the Application under development to Development effort and schedule.

Over time, two major methodologies have evolved for software application sizing: code line counting and Function Point Counting. Code line counting involves, not surprisingly, counting the lines of code in a software application. The most attractive aspect of code line counting is that it is simple and involves little or no subjective interpretation—as such, code line counting can be fairly well-suited for budgeting. The problem with code line counting is that it is very difficult to predict how many lines of code will be needed to accomplish a particular unit of functionality early in project development, unless the particular functionality has already been substantially created, and now merely requires adaptation. For new, previously unknown functionality, estimating project management functions is, therefore, virtually impossible. [BOEHM00] In fact, it is only after a software project is completed that an LOC be performed accurately.

Due to the limitations of code line counting, the process known as Function Point Analysis or Function Point Counting has evolved. Function Point Analysis is a method for the sizing of software applications based on a method originally developed by Alan Albrecht in the late 1970's. Since then, the International Function Point Users Group (IFPUG) has accepted the charter to maintain and publish the approved Counting Practices Manual (CPM). Unlike code line counting, Function Point Counting is very well suited for estimating and project management, and can also perform well in budgeting, particularly when certain interpretive variables are stabilized. [KEMERER87]

Function Point Analysis involves, essentially, a two-step process. The first step involves determining an Unadjusted Function Point value or UFP. The Unadjusted Function Point value is, essentially, a measure of the functionality of the software application being sized. The second step involved in Function Point Analysis is determination of the Value Adjustment Factor or VAF. The Value Adjustment Factor is a qualitative factor that is used to account for the environmental and internal application complexity. The combination (or product) of these two values (i.e. the UFP and the VAF) produces the Adjusted Function Point Count value for the particular software application.

Referring to FIG. 1, we can analyze the steps involved in conducting a manual Function Point Count (such as for budgeting) using the conventional process. FIG. 1 is a flow diagram of the conventional manual Function Point Counting process. Step 110 involves establishing the boundary of the application; this boundary is determined from the user's perspective. Although the boundary can be defined in many ways, it is a common practice for software design personnel to use object-oriented design techniques to establish the boundaries and functionality of a particular software application. In fact, a variety of design tools have evolved that incorporate the design methodology known as Universal Modeling Language or UML. Essentially, using the object-oriented design model involves defining a number of objects and methods (functionality) of the software application, and then relating the group of objects within the application boundary to one another. To date, however, UML has only really been used by the design team, and not very widely by Function Point Counting technicians.

Once step 110 is completed (by whatever method the FPC technician chooses), the technician will then execute Step 120, which is to identify and classify the logical collections of data. Logical collections of data, for the purposes of Function Point Counting, are typically one of two types: either Internal Logical Files (ILF's) or External Interface Files (EIF's). Essentially, an internal logical file is typically a record or file within the domain of the application under development where data is stored and/or manipulated by either the application, user, or something external to the application. An external interface file is similar to an ILF, except it is a file (that is referenced or read by the application being counted) that is stored external to the domain of the application under development. Upon identifying and classifying the various logical collections of data as either ILF or EIF's (depending upon their relationships to the domain of the application under development), the Function Point Counting technician will execute Step 130. Step 130 involves the identification and classification of functional transactions with the subject software application, generally broken down into one of three types: an External Input type (EI), External Output type (EO), or an External Inquiry type (EQ). It should be understood that analysis and/or classification of the logical collections of data and transactional functions is an iterative process in this manual Function Point process, and in fact, the Function Point Counting technician will typically arrive at the final conclusions of Step 120 and Step 130 by observing actual operations of the software package to validate his or her own assumptions regarding the logical collections of data and transactional functions. It should be noticed that as the software under development evolves, frequent interaction with designers is required, which requires substantial effort and extensive resources. Furthermore, the FPC technician's subjective analysis of steps 120 and 130 may have significant effect on the eventual outcome of the Count. A measure of the tendency for a group of FPC technicians to arrive at the same Count for the same software application is called the Inter-rater Reliability. Under prior (non-Function Point Analysis) methods, inter-rater reliability is perceived to be too low. FIG. 4 below will discuss how an estimated Function Point Count for a prospective software application package is conducted.

FIG. 2 is an example of an object-oriented design for a portion of a payroll system application. As can be seen in FIG. 2, there are four defined objects: the payroll system, the user transactions with the payroll system, the external data source(s) for, and the external output(s) from the payroll system. As can be seen, FIG. 2 depicts examples of all transaction types as well as the logical collection of data types as discussed previously in connection to FIG. 1. It should be understood that this is a very simple example provided to give the reader a peripheral understanding of object-oriented representation. The problem with the use of object-oriented design for software implementation is that, while there are object-oriented design tools that are in fairly wide use for software applications, there has previously been virtually no way of using the output of these software-based object-oriented design tools to automatically calculate the Function Point Count for the application under design.

As discussed above, steps 120 and 130 include the classification and/or characterization of the various objects in the object oriented design. If the technician was conducting Steps 120 and 130 on the partial system represented in FIG. 2, a table similar to that shown in FIG. 3 might be used. FIG. 3 is a table demonstrating how an Unadjusted Function Point Count is calculated. FIG. 3 is a table of values for the different transaction types and logical data types (as previously discussed). As the technician is performing Steps 120 and 130, he or she must determine what level of complexity each transaction or data collection has, based on rules defined in the IFPUG Counting Practices Manual. [IFPUG94]Once determining the level of complexity, the technician can multiply the appropriate value from FIG. 3 in order to calculate the total Unadjusted Function Point or UFP. In this case, the example in FIG. 2 has a UFP of 41.

Referring back to FIG. 1, next, the Function Point Counting technician will execute step 150, which is to assess the general system characteristics (found in the IFPUG Counting Practices Manual). This assessment involves calculating a number of discrete characteristics, with the goal of trying to capture the general complexity or functionality of the software package as a whole. These weights are totaled to result in the VAF (Value Adjustment Factor). The final Adjusted Function Point Count (AFP) is equal to the UFP times the VAF. In this example let us assume that the Value Adjustment Factor is 1, meaning that, generally speaking, the application is of average load, average complexity and/or functionality, resulting in a final adjusted Function Point Count or AFP of 1×41=41.

Now that we have discussed the general process involved in arriving at a Function Point Count we will discuss a particular application for a Function Point Count—in this case it is the Budget Count (see FIG. 4). As a preliminary step, the software application must be either created and/or modified in some way since the last sizing process has been accomplished (Step 90), or changes have been proposed and these requirements have been defined. Once Step 90 is completed, the application boundary is studied and defined (or reviewed and updated) as discussed earlier in connection with FIG. 1. Once the application boundaries have been defined or reviewed, the adjusted Function Point Count can be calculated (or re-calculated/reviewed) (this is Steps 120-140). On an as-needed basis then, the Adjusted Function Point can be recalculated, however, it should be understood that many modifications might, and typically do occur to the software application between each Function Point Counting. This is because a manual Function Point Count is typically very labor-intensive and therefore costly. As such, several modifications (to the software application) might be accomplished, while Function Points are typically only counted once a year or less. It should also be appreciated that each time a new Function Point or sizing is desired, the application boundary must first be studied/reviewed and defined again (i.e. re-execute Steps 110-130).

Now turning to FIG. 5, we can examine one conventional process for estimating the size of a projected software application. FIG. 5 is flow diagram of a conventional estimate-type Function Point Count. As discussed above, this might be done in advance of bidding on a particular project to be completed for a client. As a first step, the potential customer must provide input containing the detailed application requirements to the software developer. Many times these detailed application requirements are the result of extensive discussion between the software programmers and the potential customer. It is generally an iterative process where the designer and the customer work together to define the application requirements. Once the requirements are determined, the software application boundary is established, (Step 110). Next, the logical collections of data are identified and given an average weight (AW) depending upon their expected complexity (Step 121). Step 131 involves the identification of the transactional functions and, again, assigning an Average (or Estimated) Weight (AW) to each one. Step 141 involves the calculation of the estimated Unadjusted Function Point UFP_{(AW)}—this is equal to the sum or the values arrived at in Steps 121 and 131. Similar to the budgeting process, the VAF is determined (Step 150), and then Step 161 is accomplished, which is the arrival at the Adjusted Function Point (calculated as an estimate by AW). This AFP_{(EST, AW)} is the UFP_{(AW)} multiplied by the VAF, which in standard notation is: <AFP_{(EST, AW)}>=<UFP_{(AW)}><VAF>.

FIG. 6 is a flow diagram that details an alternative estimating process to arrive at software application size. In this case, Step 122 replaces Step 121—the technician simply identifies the logical collections of data. Next the technician calculates the typical transactional function usage factor (Step 132), which is an average measure of the complexity and frequency of the various transactional functions. Next, the technician will conduct Step 142, which is to calculate the Typical Unadjusted Function Point, UFP_{(TYP)}—this is equal to the value arrived at in Step 122 multiplied by the value arrived at in Step 132. After determining the VAF, Step 162 is conducted, which is the calculation of the Adjusted Function Point (estimated by typical transactions). This AFP_{(EST,TYP)} equals the UFP_{(TYP)} multiplied by the VAF. There is no rule as to which estimating process is used, however, it should be apparent that the process depicted in FIG. 6 is a simplification of that used in FIG. 5.

FIG. 7 depicts how the estimating counting process might be viewed in a global or generic sense. FIG. 7 is a summary flow diagram of a conventional software application estimating process, provided so that we might later explain the advancements of the present invention. As can be seen, first the detailed requirements are submitted and/or revised (Step 91). Many times, the next step is to create or revise the software design (Step 92), however, it must be understood that this step is optional, and at times is not executed (meaning that the estimated count is conducted without a design for the final product). Once the design is complete, and within the context of an iterated software development process, the application boundary is established and the pertinent characteristics assigned (Steps 110 through 132), and then the estimated Adjusted Function Point Count is calculated (Steps 141 through 162, above). These steps are repeated as needed for new submissions or additions of requirements. One should understand that if a manual Function Point Count is not continuously compared with the actual software development process, then the variance between the estimated and actual intrinsic Function Point Count grows larger. Furthermore, continuous training is necessary to maintain the inter-rater variance small through the manual Function Point Counts.

Now turning to FIG. 8, we can examine how a project count might be conducted; it is a summary flow diagram of a conventional project-type count, again presented in order to distinguish it from the process of the present invention. Similar to FIG. 7, FIG. 8 is a flow chart of the global or general steps involved or related to a project count. First, Step 91 is completed (here, no application design has been completed), after which the application boundary is defined and the Adjusted Function Point is calculated. Once the estimated Adjusted Function Point is calculated, Step 170 is executed, which is the creation of the initial project schedule and budget. Many times this step is conducted by the project manager once he or she has worked with the project designer (who has conducted the previous steps). Once the project schedule and budget are accomplished, Step 180 is executed, which is to program, test and complete the various modules of the software application. As each module or unit is completed, Step 190 is completed, which is to forecast and/or track the application development against the schedule developed in Step 170.

Upon completion of the entire project, Steps 110 through 160 must be re-conducted (and/or reviewed for changes). In other words, once the designed software application is completed, the actual Function Point must be recalculated if a final number is desired. Of course, this calculation is typically done manually, using the process discussed in connection with FIG. 1. Although there are several Function Point Counting tools, they only provide a mechanism for the analysts to record their findings. [IFPUG SITE] Furthermore, any time modifications are completed to the software application, it is common for Steps 180 and 190 to be re-executed. It should be apparent that when using this process, changes to the initial design can be difficult to analyze or capture because the changes are typically incorporated or accomplished by the design team, while it is the planners or project management staff that is responsible for reporting schedule progress and tracking application size. What would be very powerful is for the Function Point estimate and actual Function Point counts could be calculated in real time from the software application design, such that any time the design changes, a Function Point Count could automatically be produced.

### SUMMARY OF THE INVENTION

In light of the aforementioned problems associated with the prior methods and systems, it is an object of the present invention to provide an Automated System and Method for Software Application Quantification. The preferred method and system will enable a user to create an object-oriented representation of a prospective or existing software application, and then quantify the object-oriented representation with a function point count automatically created from the object-oriented model.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a flow diagram of the conventional Function Point Counting process;

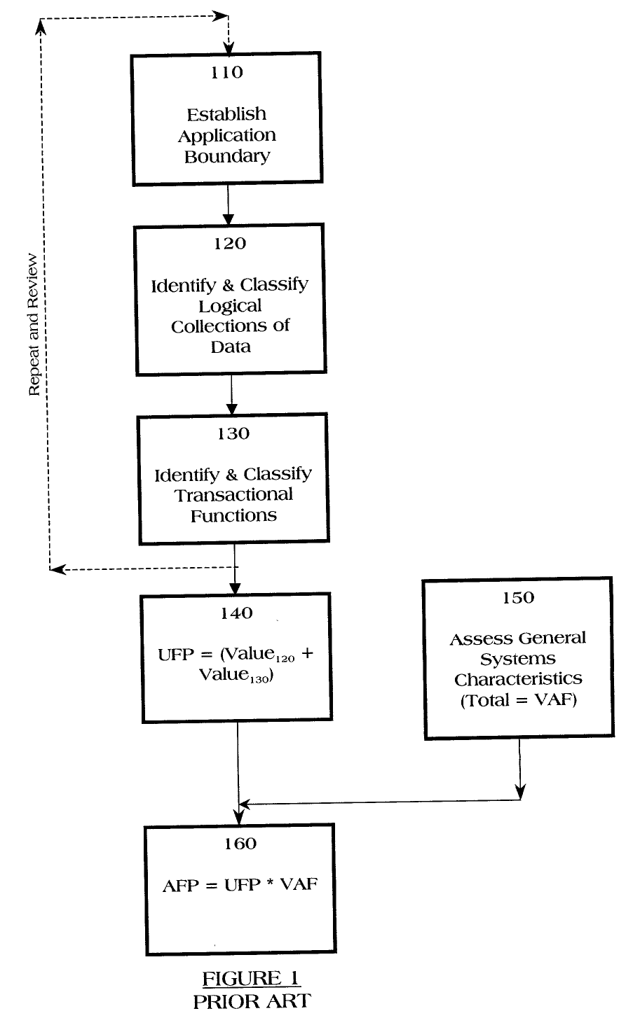

FIG. 2 is a an example of an object oriented design for a portion of a payroll system application;

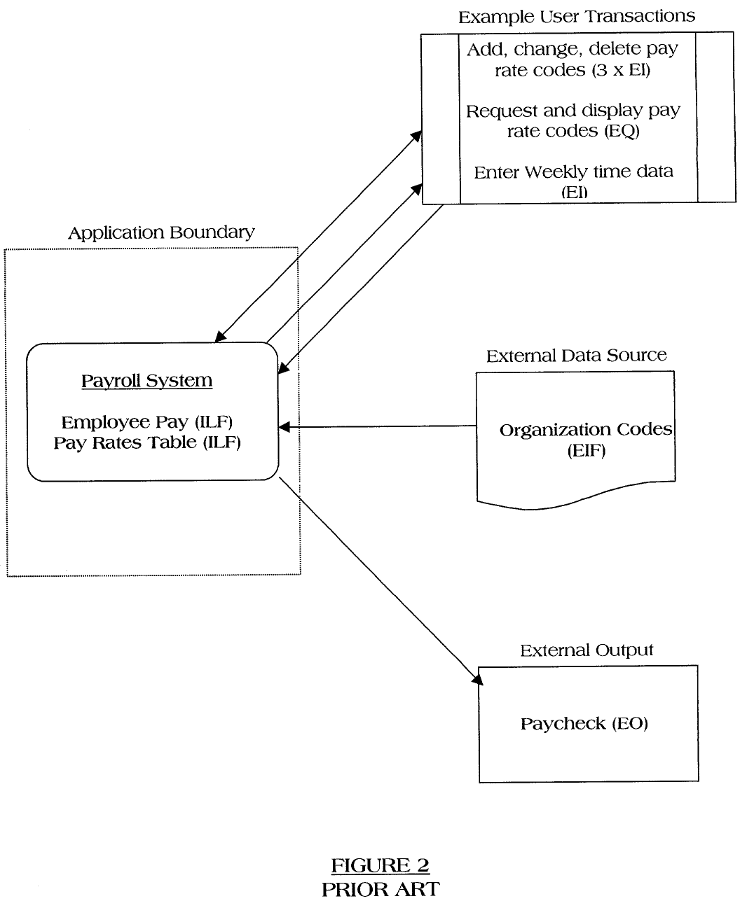

FIG. 3 is a table demonstrating how Unadjusted Function Points are calculated;

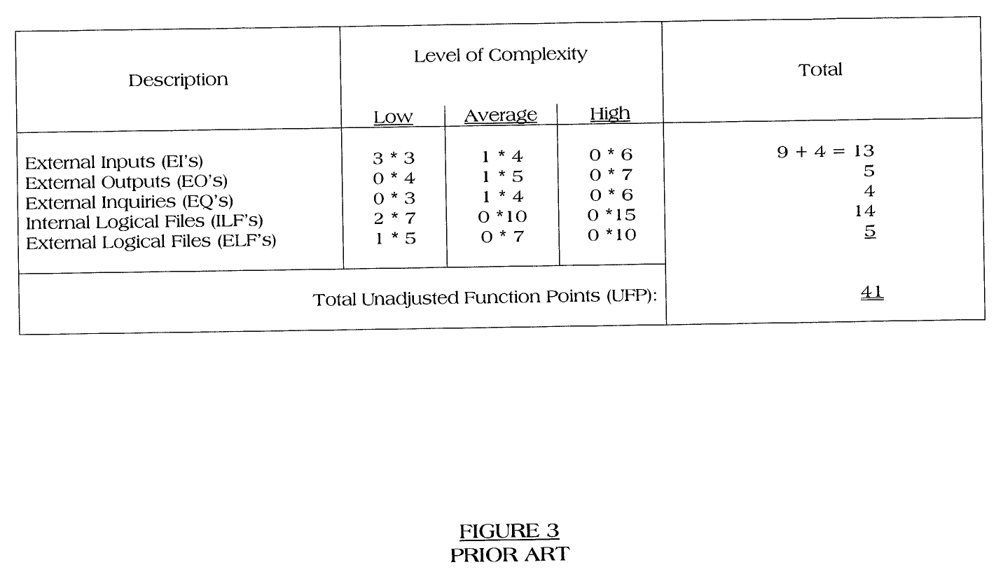

FIG. 4 is a flow diagram of a conventional budget-type count;

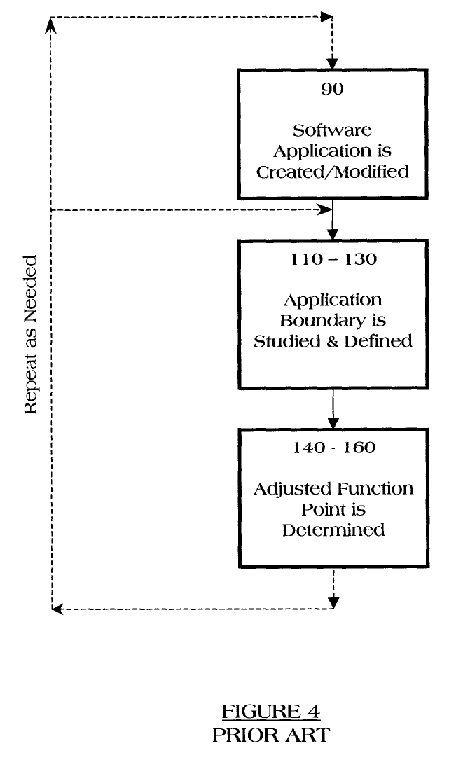

FIG. 5 is flow diagram of a conventional Function Point Count for estimating a prospective software application;

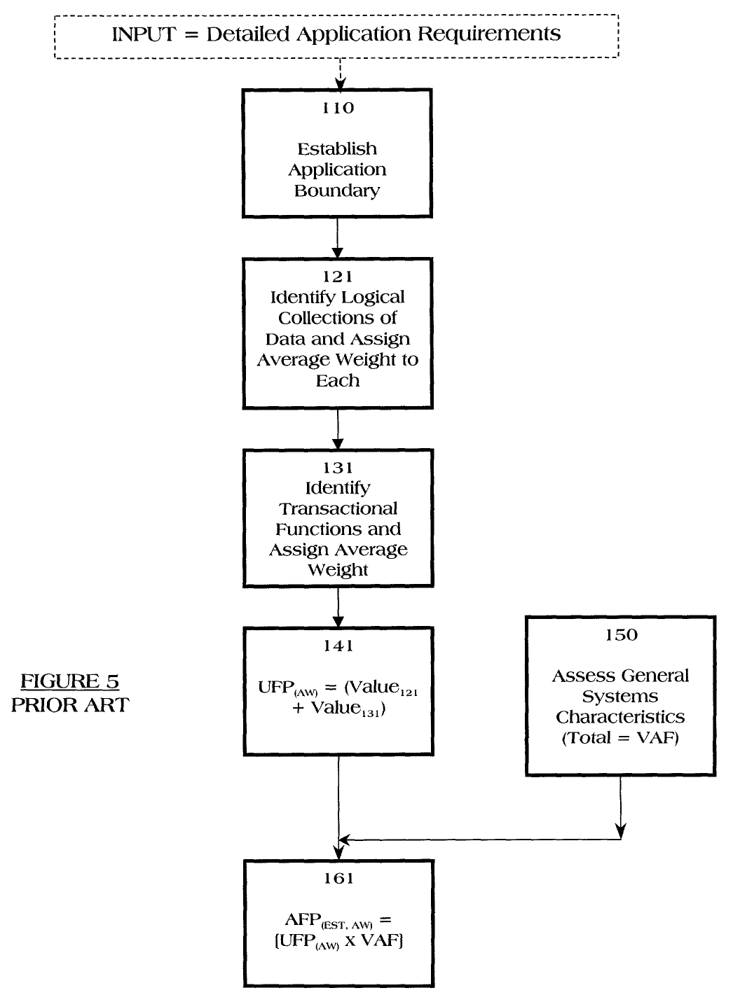

FIG. 6 is a flow diagram of an example of another process for estimating the size of a software application;

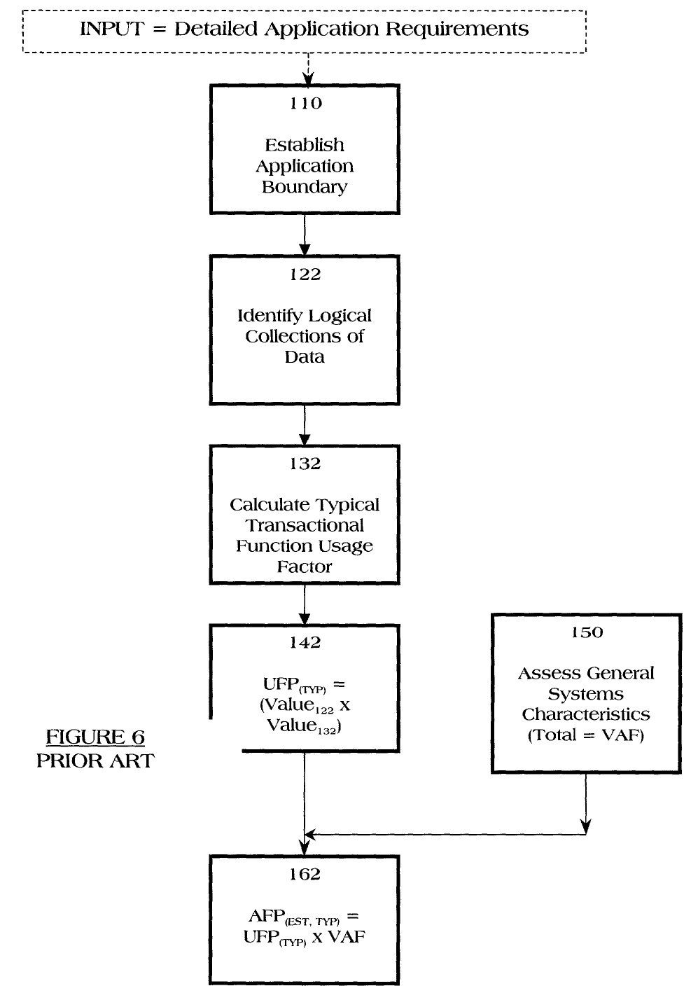

FIG. 7 is a summary flow diagram of a conventional software application estimating process;

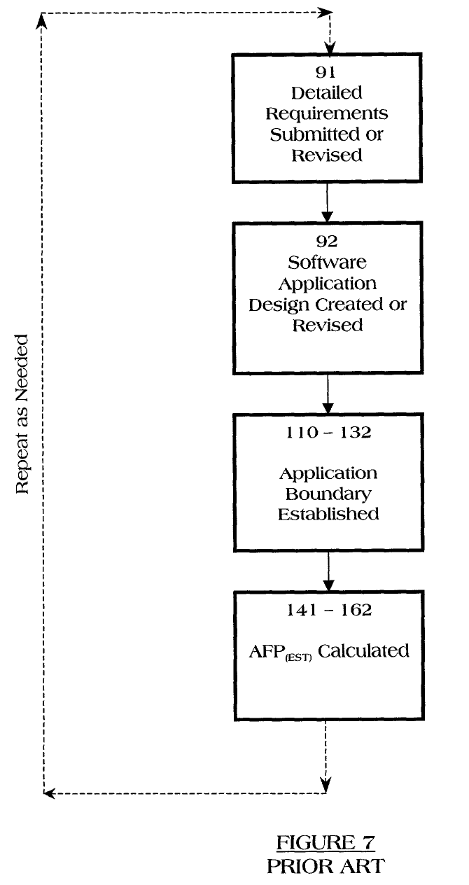

FIG. 8 is a summary flow diagram of a conventional project-type count;

FIG. 9 is a block diagram depicting how the Function Point Model can be mapped to an Object-Oriented Analysis and Design format;

FIG. 10 is a diagram of exemplary class categories;

FIG. 11 is a diagram of an exemplary category OOAD structure;

FIG. 12 is a diagram of a transactional function-type behavior; and

FIG. 13 is a flow diagram of the improved sizing process using the device and method of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide an Automated System and Method for Software Application Quantification.

Preferred Technical Approach of the Present Invention:

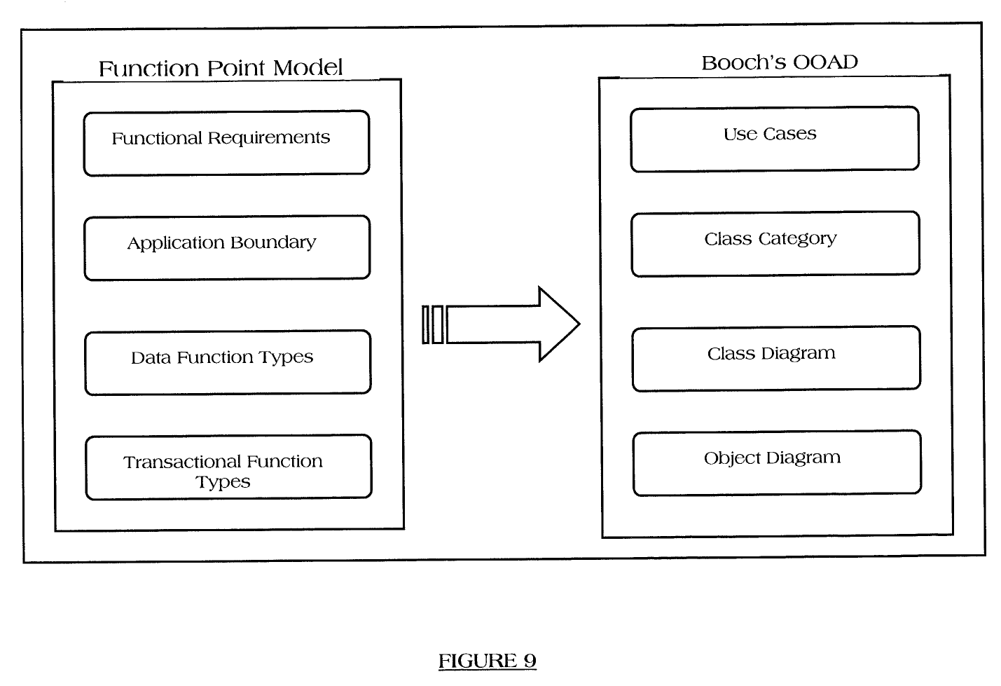

The novelty of the present approach begins with recasting Function Points into an object-oriented model, and then automating the actual Function Point Count. We note that although IFPUG has applied Function Point Counting to analyze Object Oriented Software Designs, the actual methodology has not been cast into and Object Oriented model. This approach clarifies ambiguous interpretations of the IFPUG counting rules. Ambiguous interpretations of these rules consistently plagued attempts by other researchers, as exemplified by the inter-rater variance. Consequently, this clarification provides an added benefit of potentially dramatically improving the inter-rater reliability. The object-oriented model provides all the data needed for recasting of Function Point definitions and for calculation of a Function Point value as shown in FIG. 9. FIG. 9 depicts how the IFPUG counting rules are preferably mapped to a conventional Object-Oriented Analysis and Design model.

A use case is a related sequence of transactions between the system and its user (i.e. transactional function types—EI, EO, EQ). The complete functionality of the system can be represented by the set of all use cases [JACOBSON92]. In addition, the constraints and static features of the system are described by the static requirements. Booch also recommends this approach as an aid in the analysis of the software system [BOOCH94]. Therefore, transactional function types of the Function Point model can be mapped to use cases from the object-oriented model. Likewise, the static requirements can be mapped to the VAF's.

To achieve a well-defined and consistent mapping, terminology and definitions must be established. In the present approach, all functions are defined to be a transaction performed by the software application. Consequently, a transaction is a composition of one or more atomic processes, where an atomic process is the smallest unit task or activity visible to the user. To conclude the mapping introduced in the previous paragraph, a use case is defined to be a set of ordered functions visible to the user with each transaction composed of one atomic process.

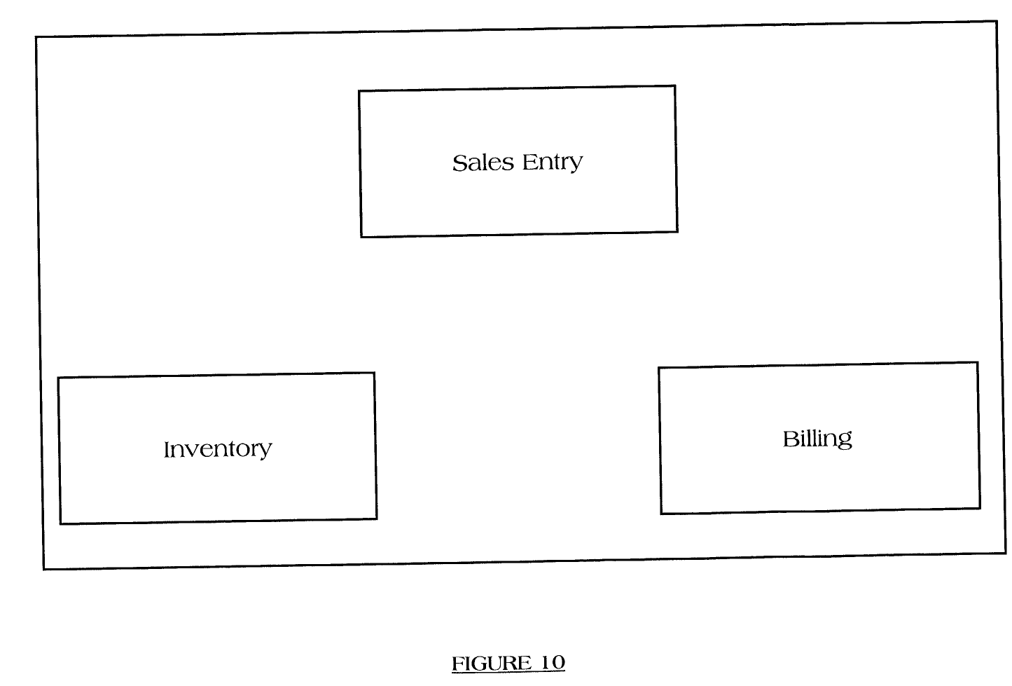

Use cases are subsequently used to define class categories and class diagrams as part of the software design process. Class categories partition the system into high-level groupings of classes and objects [WHITE94]. Class categories represent objects defining the organization of a software application. Since categories inherently build boundaries, they can be used to define the application boundary for Function Point Analysis. In FIG. 10, sales entry, inventory, and billing are examples of class categories.

The Class Category that is associated with the complete application boundary is identified as Application Class Category (ACC). All other class categories not a subcategory of the ACC are identified as of an External Class Category (ECC).

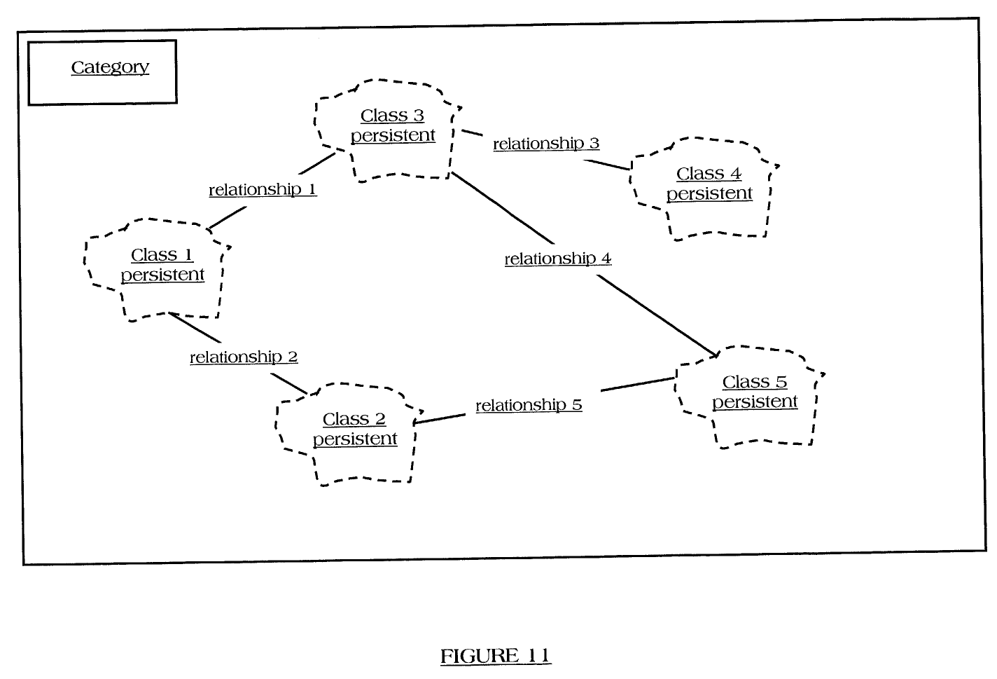

In OOAD, a class captures the common structure and common behavior of a set of objects [WHITE94]. The existence of classes and their relationships in the logical design of a system is represented in the class diagrams containing the required classes. FIG. 11 illustrates the classes (cloud-like icons) defined for one class category. The graphic representation of the class diagram clearly delineates the data that will be internal to the category, and allows us to use this OOAD technique to classify object diagrams as transactional function types.

The final OOAD technique, the object diagram, is used to validate the class diagram against the original use cases. Object diagrams describe how the object will interact to carry out key system functions [WHITE94]. By redefining object diagrams to be a description of how objects collaborate to realize a use case, an object diagram can be viewed as a graphical representation of a use case. Collaboration is an ordered set of pairwise object relationships. These relationships are “has”, “use”, “association”, and “inheritance”.

As illustrated above, the object diagram identifies the classes, the methods, and parameters which more completely define a particular use case. If the data comprising the transactional data can be extracted from an object diagram, a Function Point metric can be derived. If the data is not available, estimates are based upon statistical tendencies are used.

The novel approach of the present invention requires that each transactional function type can identify its associated data function types and the data entry types needed in the transaction. Furthermore, the data entry types needed in the transaction must be associated to the identified data function types. By definition, object diagrams identify all classes needed to complete the use case; therefore, it must identify the data function types. In addition, object diagrams define the methods used to communicate between classes (i.e. internally or externally). Parameters can be included with these methods; these parameters now become a source for the identification of data entry types. The object diagrams contain the data needed to extract information for our Function Point Analysis for each of the transactional function types.

Given that the object diagrams do contain the needed data, how easily can this data be extracted?

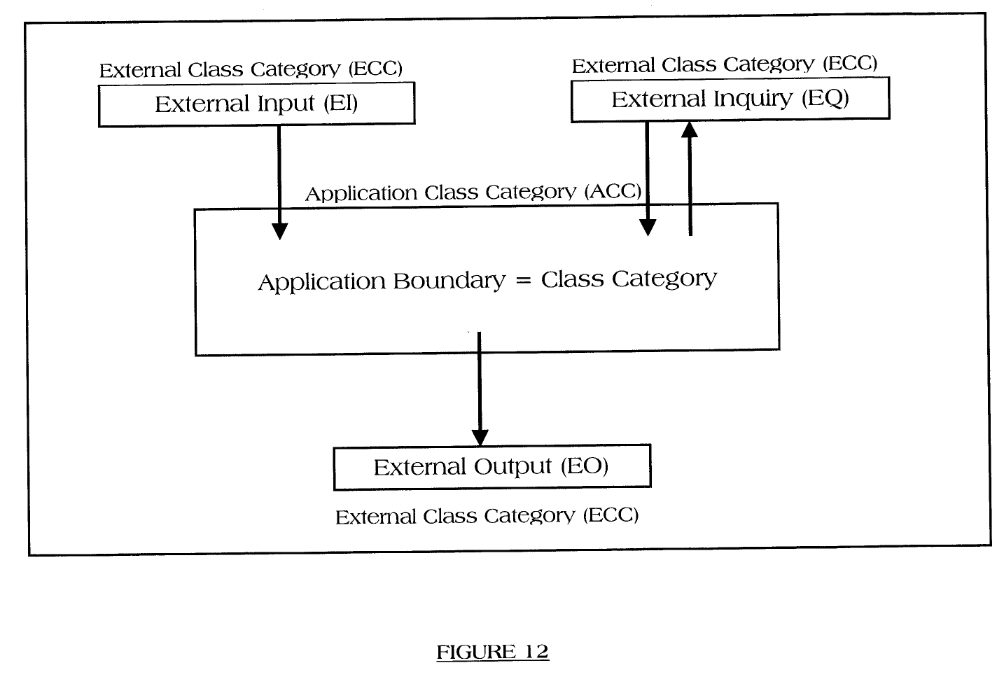

The innovative approach of the present invention detects and recognizes any data entering or exiting the Application class category so that transaction function types can be recognized and the Function Point Count can be automated. FIG. 12 illustrates behavior of the three transactional function types with respect to the class category. For example, data entering the class category but not leaving (which adds, changes, deletes data or a control function) is classified as an external input (El). Data leaving the class category but not first entering it (i.e. the data has been derived in the application) is classified as an external output (EO). Similarly, data entering and then leaving the class category (i.e. simple data retrieval) is classified as an external inquiry (EQ). Once an object diagram is classified, data associated with the transactional function types can be extracted. The extraction of the data can be done in at least three ways: examination of methods and parameters, examination of attributes within the objects at selected points within the object diagram, or a combination of both. Furthermore, separation and identification of internal logical files from external logical files must be done. This is accomplished by designing the external input object diagram to include the identification of the data that it is creating, updating, or deleting.

Although specific data type detection and classification rules can be enumerated, these specific rules will be necessarily contingent upon the specific object-oriented analysis and design technique used. for example, a partial exposition of the UML (see above) rules are:

(1). A parameterized class is not an ILF candidate.

(2). An instantiated class is an ILF candidate.

(3). Metaclass is an ILF candidate.

(4). Utility Class is not an ILF candidate.

(5). Abstract Class is not an ILF candidate.

(6). Persistent Class is an ILF candidate.

(7). If Class is both Persistent and Abstract, then Abstract overrides and it is not an ILF candidate.

Once an ILF candidate is identified then three types of relationships are analyzed: “inheritance,” “has,” “association,” and instantiation. The number of DETs are determined by counting all attributes in an ILF class.

The extraction method must be (and is) well-defined, repeatable, and not subject to a specific software design approach. Successful automation of the Function Point metric from object-oriented design diagrams allows project managers to take a proactive role from the early software lifecycle phases of the development project. Reduced costs for software development will result directly from this early and continuous insight into a project.

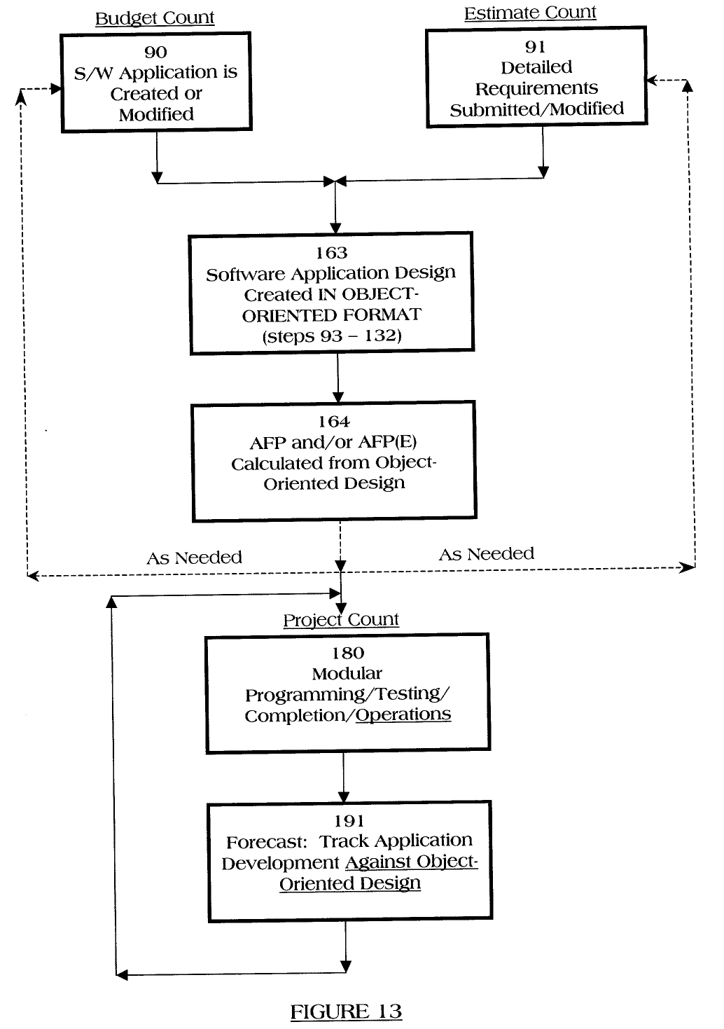

Now turning to FIG. 13 we can discuss the sizing process using the process and device of the present invention. FIG. 13 is a flow diagram of the improved sizing process using the device and method of the present invention. The improved process does not distinguish between a budget or an estimate count. Of course, for a budget the input to the process is an existing software application (Step 90), while in an estimate-type sizing process, the detailed requirements (Step 91) are the input to the process. In another case, the first step of the improved process is to create and/or revise the software application design in object oriented format (i.e. to complete Steps 93-132 discussed previously). It should be understood that when the software design team completes this design, it is done in the fashion that the design team might use to define the structure of the software application in an object-oriented form using the rules discussed above in connection with FIGS. 9-11. The difference here is that now the estimated or actual Adjusted Function Point Count can be calculated directly from the object-oriented design (i.e. Steps 140-162 are accomplished automatically and/or directly from the graphical object-oriented design created in the previous step). On an as-needed basis, therefore, if the software application is modified, or if the detailed requirements are revised, the design team simply has to revise the object-oriented design in order to immediately receive a revised Function Point Count. In practice, the Object-Oriented designer needs only to identify one ACC and one or more ECC's in order to obtain a Function Point Count; this may be performed easily via adornments or instantiating a stereotype. An adornment is a data qualifier that provides specific instructions on how to interpret its associated object (e.g. [symbol] The 1 is an adornment indicating that there is a 1 to 1 relationship, versus 1 to many, etc.). A stereotype is similar to an alias; it provides the capability to extend basic model elements.

It should be understood that while we are using the term Adjusted Function Point Count throughout this application, it is not always necessary to apply the Value Adjustment Factor. Many times the Function Point Count is simply used to benchmark and/or track relative size in software applications. In such cases, the Value Adjustment Factor is unnecessary. By eliminating the Value Adjustment Factor, the analyst has simplified the analytical process and perhaps removed opportunities for subjective introduction of error or inaccuracy (and the resultant Count would be an Unadjusted Function Point Count).

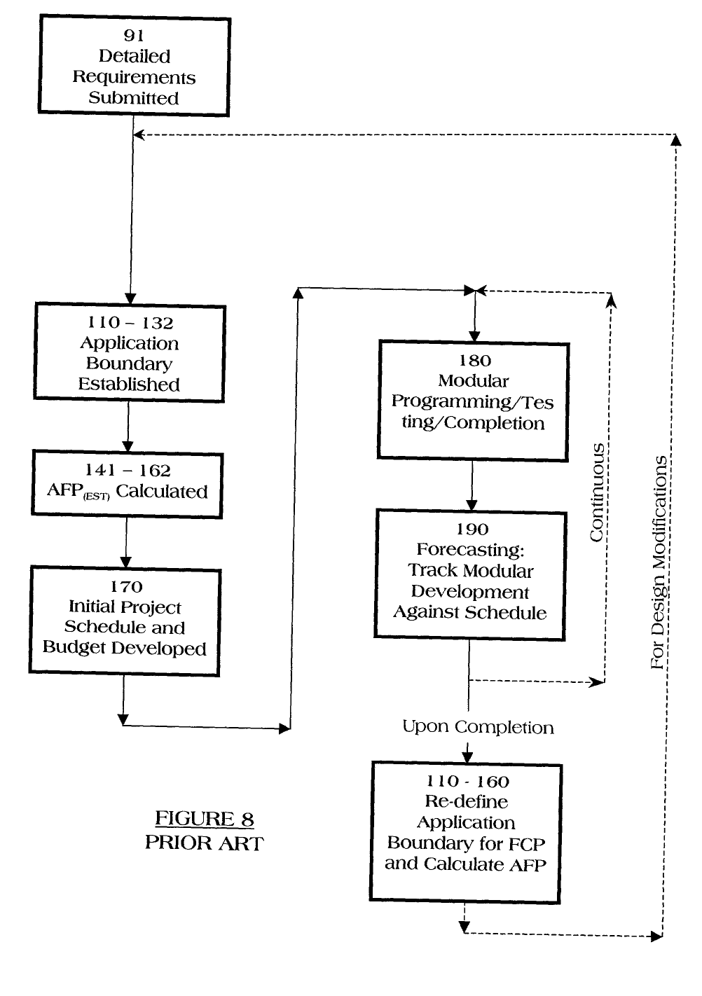

Returning to the discussion under FIG. 12, when a Function Point Count is desired for use in project monitoring, once Step 164 is completed, it should be understood that the application module is programmed, completed and tested under Step 180 and the forecasting and tracking of the application development (Step 191), is now completed in reference to the object-oriented design. Unlike the process discussed in connection with FIG. 8, the project team will no longer be creating a separate project schedule based upon the software design, but the software design and the intrinsic Function Point Count will directly result (when personnel budget is added in) in a schedule. Therefore, as functionality is completed (as defined by the object oriented application design), the corresponding Function Point Count will increase as well. Furthermore, as designs change, the design team will be involved, which will result in the object oriented-design being changed—which, again, will result in the schedule and forecasting, etc. being changed.

A significant benefit exists with regard to budget-type counting. Once this object-oriented design and automated Function Point output is created, the user need merely adjust the design and/or map of the software any time a change is made—if this is done, an actual Function Point Count can be conducted at any time that the user wishes. Furthermore, the user may track actual resource dedication and compare it to the Function Point count (which is a theoretical size), and as a result, can verify the accuracy of the application schematic or object-oriented design with the reality of the actual operations of the software application. It is conceivable that such a system or process could be used for statistical process control (SPC) to monitor the operations of any and all software development and maintenance functions.

In summary, then, the device and process of the present invention involves the direct calculation of application size from the application design. While a few of the benefits of this approach have been discussed herein, it should be understood as this process begins to experience wide implementation, other types of utility will become more fully apparent.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

### REFERENCES

[ABRAN94] Abran, A. (1994). Productivity Models: Conditions for Reliability and Ease of Use. International Function Point Users Group Fall Conference Proceedings, 37-39.

[BARLIN92] Barlin B., Lawler J. M. (1992). Effective Reuse in an Embedded Real-Time System. TRI-Ada '92 Conference, Orlando Fla., November 19.

[BOEHM00] Boehm, B., Abts, C., et al., Software Cost Estimation with COCOMO II, Prentice Hall PTR, New Jersey, 2000.

[BOOCH94] Booch, Grady (1994). Object-oriented analysis and design with applications. The Benjamin Cummings Publishing Company, Inc.

[BOOCH95] Booch, G., Rumbaugh J., Hopkins, J. (1995). Booch & Rumbaugh on tour: The evolution of object methods. Rational Software Corporation.

[COOPER94] Cooper, K. G. (1994). The $2,000 Hour: How Managers Influence Project Performance Through The Rework Cycle. IEEE Engineering Management Review, Winter, 12-23.

[GRADY94] Grady, Robert B. (1994). Successfully Applying Software Metrics. Computer, September, 20.

[IFPUG92] International Function Point Users Group (1994). Function points as Assets. Reporting to Management, 6.

[IFPUG94] Function Point Counting Practices Manual (1994, Release 4.0). International Function Point Users Group, 6-28.

[IFPUG SITE] “International Function Point Users Group” World Wide Web Site at http://www.ifpug.org.

[JACOBSON92] Jacobson, Ivar (1992). Object oriented software engineering: A use case driven approach. Addison-Wesley Publishing Company.

[JONES94] Jones, Caper (1994). Software metrics: Good, bad, and missing. Computer, September, 100.

[KEMERER90] Kemerer, Chris F. (1990). Reliability of function points measurement: A field experiment. MIT Sloan School of Management WP#3193-90-MSA, MIT Center for Information Systems Research WP #216.

[KEMERER92] Kemerer, Chris F., and Porter, Benjamin S. (November 1992). Improving the reliability of function point measurement: An empirical study. IEEE Transactions on Software Engineering, 18(11), 1021.

[KEMERER87] Kemerer, Chris F. (1987). An emprical validation of Software Cost Estimation Models. Communications of the ACM, Vol. 30, May 1987.

[LAWLER90] Lawler, J. M., Barlin B., Smith R. (October 1990). Rapid Prototyping of Message Processing Systems. MILCOM.

[LAWLER92] Lawler, J. M., Barlin, B. (February 1992). Analysis of Variance in Software Cost Estimation Models. Technical Note 1694.

[LOW90] Low, G. C., Jeffrey, D. R. (January 1990). Function points in the estimation and evaluation of software process. IEEE Transactions on Software Engineering, 16(1), 64-71.

[MAGLITTA91] Maglitta, J. (1991). Its reality time. Computerworld, 81-84.

[MOLLER93] Moller, K. H., and Paulish, D. J. (1993). Software metrics: A practitioners guide to improved product development. Chapman & Hall Computing, 27.

[NAVARRO94] Navarro, Tina M. (1994). Object-Oriented Technology Report on Function Points. PL-94-174.

[PMG95] Productivity Management Group, Inc. (1995). The Fundamentals of Function Points. 160 Lawrence Bell Drive, Suite 122, Williamsville, N.Y. 14221,2-3.

[RATCLIFF90] Ratcliff, B. R., and Rollo, A. L., Adapting function point analysis to Jackson system development. Software Engineering Journal, January 1990, 79-84.

[RUBIN91] Rubin, H.(1991). Measure for Measure. Computerworld, 77-79.

[SNELL94] Snell, M. (October 1994). Client/server development talk turns to object tools. Software Magazine, 37-48.

[SYMONS89] Symons, Charles R. (1989). Software sizing and estimating. John wiley & Sons.

[WHITE94] White, I. (1994). Using the Booch method: A Rational approach. The Benjamin Cummings Publishing Co., Inc., Redwood City Calif.

What is claimed is:

1. A method for automatically generating a Function Point Count for a software application, the method being implemented in a programmed computer comprising a processor, at least one data storage system, at least one input device and at least one output device, the method comprising the steps of:
generating, by means of the programmed computer, an object model, said object model representing the functionality of the software application, and further comprising a plurality of objects of functionality having boundaries and interrelationships between said objects;
quantifying said object model, by means of the programmed computer, by assigning a Function Point Count for said object model;
applying the output of said quantifying to at least one of the output devices.

2. The method of claim 1, wherein:
said quantifying further comprises data transaction characterization and data set characterization.

3. The method of claim 2, wherein:
said generating comprises generating an object model that further comprises an application boundary, said application boundary representing the boundaries of functionality of the software application; and
said characterizing comprises further characterizing said data sets as either internal logical files or external interface files, said internal logical files being within said application boundary, and said external interface files being external to said application boundary.

4. The method of claim 3, wherein:
said characterizing comprises further characterizing each said data transaction as either an external input, an external output, or an external inquiry.

5. A method of providing an automated system for software application quantification, the method being implemented in a programmed computer comprising a processor, at least one data storage system, at least one input device and at least one output device, the method comprising the steps of:
generating, by means of the programmed computer, an object model, said object model comprising an application boundary, said application boundary defining the boundary of said software application;
storing said object model in at least one of the data storage systems;
associating, by means of the programmed computer, said object model with the software application;
first detecting, by means of the programmed computer, data transactions that cross said application boundary;
first characterizing, by means of the programmed computer, said detected boundary-crossing data transactions;
second detecting, by means of the programmed computer, and responsive to said first detecting, data sets influenced by said boundary-crossing data transactions;
second characterizing, by means of the programmed computer, and responsive to said first detecting, said influenced data sets;
quantifying, by means of the programmed computer, the size of said software application responsive to said first and second detecting and characterizing; and
applying the output of said quantifying to at least one of the output devices.

6. The method of claim 5, wherein said first characterizing step further comprises characterizing said detected data transactions as either an external input, an external output, or an external inquiry.

7. The method of claim 6, wherein said second characterizing step further comprises characterizing a said data set as an external interface file if said detected influencing data transaction crosses said application boundary.

8. A method for automating the process of quantifying a software application, the method being implemented in a programmed computer comprising a processor, at least one data storage system, at least one input device and at least one output device, the method comprising the steps of:
generating, by means of the programmed computer, an object model, said object model comprising an application boundary, said application boundary defining the boundary of the software application;
storing said object model in at least one of the data storage systems;
associating, by means of the programmed computer, said object model with the software application;
first detecting, by means of the programmed computer, data transactions that cross said application boundary;
first characterizing, by means of the programmed computer, said detected boundary-crossing data transactions;
second detecting, by means of the programmed computer, and responsive to said first detecting, data sets influenced by said boundary-crossing data transactions;
second characterizing, by means of the programmed computer, and responsive to said first detecting, said influenced data sets;
quantifying, by means of the programmed computer, the size of said software application responsive to said first and second detecting and characterizing; and
applying the output of said quantifying to at least one of the output devices.

9. The method of claim 8, wherein said second characterizing step further comprises characterizing a said data set as an external interface file if said detected influencing data transaction crosses said application boundary.

10. The method of claim 9, wherein said first characterizing step further comprises characterizing said detected data transactions as either an external input, an external output, or an external inquiry.
